(19) United States
(12) Patent Application Publication
(10) Pub. No.: US 2024/0302511 A1
(43) Pub. Date: Sep. 12, 2024

(54) DISTANCE MEASUREMENT SYSTEM

(71) Applicant: Panasonic Intellectual Property Management Co., Ltd., Osaka (JP)

(72) Inventors: SHINYA OKAMOTO, Kyoto (JP); KATSUYA NOZAWA, Osaka (JP); TASUKU NAKAMURA, Osaka (JP); YASUHISA INADA, Osaka (JP)

(21) Appl. No.: 18/668,290

(22) Filed: May 20, 2024

Related U.S. Application Data
(63) Continuation of application No. PCT/JP2022/029273, filed on Jul. 29, 2022.

(30) Foreign Application Priority Data
Dec. 10, 2021 (JP) 2021-200856

(51) Int. Cl. G01S 7/497; G01S 7/481; G01S 7/487; G01S 7/493

(52) U.S. Cl. CPC G01S 7/4972; G01S 7/4818; G01S 7/4876; G01S 7/493

(57) ABSTRACT

A distance measurement system includes a light source, a wavelength conversion module that generates a harmonic G₁ with which a target S is to be irradiated as guide light by converting a wavelength of a part of a fundamental wave L₁ of light L₀ emitted from the light source, a photodetector that detects reflected light L₁ᵣ generated by reflection, on the target S, the fundamental wave L₁ that has passed through the wavelength conversion module, and a signal processing unit that calculates a distance to the target S on the basis of a detection result of the photodetector.

### BACKGROUND

### 1. Technical Field

The present disclosure relates to a distance measurement system.

### 2. Description of the Related Art

Along with automation of production processes such as processing and assembling in a factory, demands for a high-precision sensor for automatic inspection of a shape and a dimension are increasing. In particular, a laser sensor that measures a distance by irradiating a target with laser light and detecting reflected light is capable of measuring a distance with high accuracy in a non-contact manner and therefore has been attracting attention.

Japanese Unexamined Patent Application Publication No. 2009-270939 discloses an example of an optical displacement meter including a guide light source device. Japanese Unexamined Patent Application Publication No. 62-151827 discloses an example of a device that generates a second harmonic on an optical axis identical to near-infrared laser light used for a surgical operation and processing and uses the second harmonic as guide light.

### SUMMARY

One non-limiting and exemplary embodiment provides a distance measurement system that can introduce guide light for checking a measurement position onto an optical axis identical to light for distance measurement.

In one general aspect, the techniques disclosed here feature a distance measurement system including a light source; a wavelength conversion module that generates a harmonic with which a target is to be irradiated as guide light by converting a wavelength of a part of a fundamental wave of light emitted from the light source; a detector that detects reflected light generated by reflection, on the target, of the fundamental wave that has passed through the wavelength conversion module; a processing circuit that calculates a distance to the target on the basis of a detection result of the detector; and an optical element that is disposed on a light incident side relative to the detector and whose passband includes the fundamental wave and whose cut-off band includes the harmonic, in which the optical element is an isolator or an optical fiber having wavelength selectivity.

According to the present disclosure, guide light for checking a measurement position can be introduced onto an optical axis identical to light for distance measurement.

It should be noted that general or specific embodiments may be implemented as a device, an apparatus, a system, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic view schematically illustrating an example of a distance measurement system according to Embodiment 1 of the present disclosure;

FIG. 2 is a schematic view schematically illustrating an example of a distance measurement system according to Embodiment 2 of the present disclosure;

FIG. 3 is a schematic view schematically illustrating an example of a distance measurement system according to Embodiment 3 of the present disclosure;

FIG. 4 is a schematic view schematically illustrating an example of a distance measurement system according to Embodiment 4 of the present disclosure; and

FIG. 5 schematically illustrates a frequency spectrum of light emitted from an optical frequency comb light source.

### DETAILED DESCRIPTIONS

### Underlying Knowledge Forming Basis of the Present Disclosure

Knowledge found by the inventors of the present invention are described before describing embodiments of the present disclosure.

A laser distance sensor that measures a distance and displacement in a non-contact manner is used for inspection of a shape and a dimension of an electronic device, an electronic component, an on-board component, a processed product, and the like. In an actual site of use, it is desired to be able to check a laser irradiation position in a scene such as inspection or device maintenance. In a case where a laser for distance measurement has a wavelength of low visibility, use of guide light makes it possible to check a laser irradiation position.

Japanese Unexamined Patent Application Publication No. 2009-270939 discloses an example of an optical displacement meter including a guide light source device in addition to a broadband light source device for measurement. However, according to the technique of Japanese Unexamined Patent Application Publication No. 2009-270939, members such as a guide light source and a drive power source for the guide light source are needed in addition to a light source for distance measurement. This invites an increase in cost and size of a distance measurement system.

The inventors of the present invention found the above problem and arrived at a novel distance measurement system for solving this problem.

Specifically, a distance measurement system according to an aspect of the present disclosure includes a light source, a wavelength conversion module that generates a harmonic with which a target is to be irradiated as guide light by converting a wavelength of a part of a fundamental wave of light emitted from the light source, a detector that detects reflected light generated by reflection, on the target, of the fundamental wave that has passed through the wavelength conversion module, and a processing circuit that calculates a distance to the target on the basis of a detection result of the detector.

This makes a light source exclusive for guide light and a drive device for this light source unnecessary, thereby making it possible to realize a low-cost and small-sized system and to check a position where a target is irradiated with light for distance measurement. Therefore, by using the distance measurement system according to the present aspect for inspection or maintenance, efficiency of these works can be improved.

Note that Japanese Unexamined Patent Application Publication No. 62-151827 discloses an example of a near-infrared laser device using a second harmonic of near-infrared light as guide light. However, in a case where the technique of Japanese Unexamined Patent Application Publication No. 62-151827 is applied to distance measurement, guide light is detected as noise, and therefore distance measurement accuracy decreases.

On the other hand, the distance measurement system according to the aspect of the present disclosure may include an optical element that is disposed on a light incident side relative to the detector and whose passband includes the fundamental wave and whose cut-off band includes the harmonic.

This can make it less likely that reflected light generated by reflection of guide light on the target enters the detector, thereby increasing distance measurement accuracy.

For example, the optical element may be a long pass filter or an isolator or an optical fiber having wavelength selectivity.

For example, the wavelength conversion module may include an optical crystal that generates the harmonic by converting the wavelength of the part of the fundamental wave of the light emitted from the light source; and the distance measurement system may further include an adjustment mechanism that adjusts a temperature or a posture of the optical crystal.

This makes it possible to adjust an intensity of guide light. For example, in a case where guide light is unnecessary, noise occurring due to the reflected light of the guide light can be kept small by reducing an intensity of the guide light, and thereby distance measurement accuracy can be increased.

For example, the wavelength conversion module may include an optical crystal that generates the harmonic by converting the wavelength of the part of the fundamental wave of the light emitted from the light source; and the distance measurement system may further include an adjustment mechanism that adjusts a position of the optical crystal so that the optical crystal can be selectively located at a first position on a path of the light and a second position deviated from the path of the light.

This can switch between irradiation and stoppage of the guide light. For example, in a case where the guide light is unnecessary, noise occurring due to the reflected light of the guide light can be substantially eliminated by stopping emission of the guide light, and thereby distance measurement accuracy can be further increased.

For example, an optical intensity of the harmonic may be lower than an optical intensity of the fundamental wave that has passed through the wavelength conversion module.

This can keep noise occurring due to the reflected light of the guide light small, thereby increasing distance measurement accuracy.

For example, the light source may be a pulse laser light source.

This makes it possible to measure displacement of the target by a Time of Flight (ToF) method.

For example, the light source may be an optical frequency comb light source. For example, the light may have a spectrum width wider than a width of a change of a phase-matched wavelength of the wavelength conversion module caused by a change in temperature upon irradiation of the light from the light source. For example, the spectrum width of the light may be greater than or equal to 2 nm and less than or equal to 500 nm.

Since light emitted from the optical frequency comb light source has a wide spectrum width, it is possible to cope with a change in characteristics of the wavelength conversion module. That is, since the light emitted from the optical frequency comb light source easily satisfies a condition on which a harmonic is generated by the wavelength conversion module, and it is therefore possible to provide a distance measurement system that is resistant to a change in operation environment such as a temperature and has high robustness.

For example, the light source may be a frequency modulated continuous wave (FMCW) light source.

For example, this makes it possible to measure not only displacement of the target, but also a traveling speed.

Exemplary embodiments of the present disclosure are described below with reference to the drawings. Note that detailed description more than necessary may be omitted in the following description. For example, detailed description of well-known matters may be omitted. Substantially identical constituent elements are given identical reference signs, and repeated description thereof may be omitted. This is to prevent the following description from becoming unnecessarily redundant and facilitate understanding of a person skilled in the art. The inventors of the present invention provide the attached drawings and the following description so that a person skilled in the art can fully understand the present disclosure. These are not intended to limit the subject matters described in the claims.

That is, each of the embodiments below illustrates a general or specific example. Numerical values, shapes, materials, constituent elements, positions of the constituent elements, a way in which the constituent elements are connected, steps, an order of steps, and the like in the embodiments below are examples and are not intended to limit the present disclosure. Among the constituent elements in the embodiments below, constituent elements that are not recited in the independent claims are described as optional constituent elements.

Each drawing is a schematic view and is not necessarily strict illustration. Therefore, for example, scales and the like in the drawings do not necessarily match. In the drawings, substantially identical constituent elements are given identical reference signs, and repeated description thereof is omitted or simplified.

### Embodiment 1

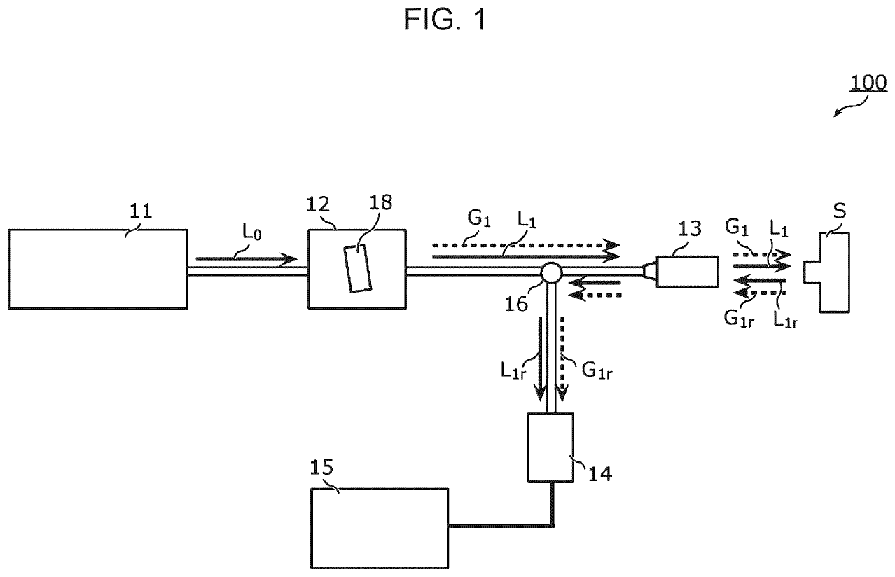

First, an outline of a distance measurement system according to Embodiment 1 is described by using FIG. 1.

FIG. 1 is a schematic view schematically illustrating an example of a distance measurement system 100 according to an exemplary embodiment of the present disclosure.

The distance measurement system 100 illustrated in FIG. 1 measures a distance to a target S. The distance measurement system 100 thus can obtain information concerning a position, displacement, a traveling speed, and the like of the target S. Furthermore, the distance measurement system 100 can obtain information concerning a shape and/or a dimension of the target S by measuring a distance for each portion of the target S.

As illustrated in FIG. 1, the distance measurement system 100 includes a light source 11, a wavelength conversion module 12, an optical head 13, a photodetector 14, a signal processing unit 15, and an optical circulator 16. Furthermore, the distance measurement system 100 includes an optical fiber for transmitting light to a desired constituent element. In FIG. 1, the optical fiber is indicated by the double lines connecting the constituent elements.

Specifically, the optical fiber connects the light source 11 and the optical head 13 and connects the optical head 13 and the photodetector 14. The wavelength conversion module 12 and the optical circulator 16 are disposed between the light source 11 and the optical head 13. The optical circulator 16 is an optical element used for distributing light and can guide reflected light L₁ᵣ and G₁ᵣ incident on the optical head 13 to the photodetector 14.

The light source 11 emits light L₀ for distance measurement. The light source 11 is, for example, selected from the group consisting of a pulse laser light source, an optical frequency comb light source, and a frequency modulated continuous wave (FMCW) light source.

The light L₀ for distance measurement has a peak wavelength in a wavelength band other than visible light. Specifically, the light L₀ has a peak wavelength in a wavelength band longer than visible light. For example, the light L₀ is near-infrared light and has a peak wavelength in a wavelength band greater than or equal to 780 nm and less than or equal to 2500 nm. Note that the peak wavelength is a wavelength at which an intensity is highest in a spectrum of light. The peak wavelength is, for example, 1550 nm.

The wavelength conversion module 12 generates a harmonic G₁ with which the target S is to be irradiated as guide light by converting a wavelength of a part of a fundamental wave L₁ of the light L₀ emitted from the light source 11. The wavelength conversion module 12 includes, for example, an optical crystal 18 that generates the harmonic G₁ by converting a wavelength of a part of the fundamental wave L₁ of the light L₀.

The optical crystal 18 is, for example, a second harmonic generation (SHG) crystal that generates a second harmonic of the fundamental wave L₁ as the harmonic G₁. The optical crystal 18 can be, for example, an optical crystal made of one kind selected from the group consisting of lithium triborate (LBO: LiB₃O₅), beta-barium borate (BBO: β-BaB₂O₄), potassium dihydrogen phosphate (KDP: KH₂PO₄), potassium titanyl phosphate (KTP: KTiOPO₄), and lithium niobate (LiNbO₃). Alternatively, the optical crystal 18 may be, for example, an optical crystal made of one kind selected from the group consisting of periodically poled lithium niobate (PPLN) and periodically poled lithium tantalate (PPLT).

The harmonic G₁ is, for example, visible light. Specifically, the harmonic G₁ has a peak wavelength in a wavelength band greater than or equal to 380 nm and less than or equal to 780 nm. In this case, the harmonic G₁ is visible light that can be perceived by human eyes and therefore can be used as guide light. For example, the optical crystal 18 is adjusted to generate the harmonic G₁ while using a wavelength component of the peak wavelength of the light L₀ as the fundamental wave L₁. In this case, in a case where the peak wavelength is 1550 nm, a second harmonic whose peak wavelength is 775 nm is emitted as the harmonic G₁ from the optical crystal 18. Note that the harmonic G₁ may be a third harmonic, a fourth harmonic, or the like instead of the second harmonic of the fundamental wave L₁. An optical intensity of the harmonic G₁ is, for example, lower than an optical intensity of the fundamental wave L₁ that has passed through the wavelength conversion module 12. Note that the harmonic G₁ used as guide light is not limited to visible light. For example, in a case where the harmonic G₁ is ultraviolet light and the target S contains a fluorescent substance that shows fluorescence under the ultraviolet light, an irradiation position can be checked on the basis of a position of fluorescence emitted from a surface of the target S.

Light of the fundamental wave L₁ that is not subjected to the wavelength conversion passes through the optical crystal 18 as it is. That is, the optical crystal 18 emits the fundamental wave L₁ and the harmonic G₁. The fundamental wave L₁ is light for distance measurement. The harmonic G₁ is guide light that indicates an irradiation position of the fundamental wave L₁. The fundamental wave L₁ and the harmonic G₁ are light that comes from the same light source 11 and is emitted from the optical crystal 18. Accordingly, optical axes of the fundamental wave L₁ and the harmonic G₁ emitted from the optical crystal 18 match. Note that the optical axes correspond to a path of laser light.

The optical head 13 coaxially emits, toward the target S, the fundamental wave L₁ and the harmonic G₁ that have passed through the wavelength conversion module 12. The optical head 13 may include, for example, a collimator that turns light into parallel light and emits the parallel light.

On the optical head 13, reflected light L₁ᵣ and reflected light G₁ᵣ, which are the fundamental wave L₁ and the harmonic G₁ reflected by the target S, are incident. The reflected light L₁ᵣ is light generated by reflection of the fundamental wave L₁ by the target S. The reflected light G₁ᵣ is light generated by reflection of the harmonic G₁ by the target S.

The photodetector 14 is an example of a detector that detects the reflected light L₁ᵣ. The photodetector 14 detects at least the reflected light L₁ᵣ, which is one of the reflected light beams L₁ᵣ and G₁ᵣ generated by reflection on the surface of the target S. The photodetector 14 is, for example, a photoelectric conversion element such as a photodiode or a phototransistor. The photodetector 14 generates an electric signal according to an intensity of the incident light and outputs the electric signal to the signal processing unit 15.

The signal processing unit 15 is an example of a processing circuit and calculates a distance to the target S on the basis of a detection result of the photodetector 14. Specifically, the signal processing unit 15 converts the electric signal output from the photodetector 14 into distance information indicative of a distance to a light irradiation position of the target S. For example, the signal processing unit 15 calculates the distance on the basis of a ToF method or an FMCW method.

The signal processing unit 15 is, for example, realized by large scale integration (LSI), which is an integrated circuit (IC). Note that the integrated circuit is not limited to the LSI and may be a dedicated circuit or a general-purpose processor. For example, the signal processing unit 15 may include a non-volatile memory in which a program is stored, a volatile memory that is a temporary storage region for execution of a program, an input/output port, and a processor that executes a program. The signal processing unit 15 may be a field programmable gate array (FPGA) that can be programmed or a reconfigurable processor that allows reconfiguration of the connection or setup of circuit cells inside the LSI. Functions executed by the signal processing unit 15 may be realized by software or may be realized by hardware.

According to the distance measurement system 100 according to the present embodiment, the light L₀ emitted from the light source 11 is incident on the wavelength conversion module 12, and the fundamental wave L₁ emitted from the wavelength conversion module 12 is used as light for distance measurement and the harmonic G₁ emitted from the wavelength conversion module 12 is used as guide light. Since an optical axis of the light for distance measurement and an optical axis of the guide light are identical, an irradiation position of the light for distance measurement can be checked with high accuracy. Furthermore, since the target S can be irradiated from the front with the light for distance measurement and the guide light, reflected light of the light for distance measurement can be easily received. Since a path along which the light for distance measurement travels back and forth is stable, accuracy of distance measurement based on a period of the back and forth traveling of the light can be increased.

Furthermore, the distance measurement system 100 does not need a light source exclusively for emitting guide light and a drive power source for this light source and a component for introducing the guide light onto an optical axis identical to light for distance measurement. This allows a reduction in size and cost of the distance measurement system 100. A position at which the target S is irradiated with light for distance measurement can be easily visually checked on the basis of guide light by using the small-sized distance measurement system 100.

### Embodiment 2

Next, Embodiment 2 is described.

A distance measurement system according to Embodiment 2 is different from the distance measurement system according to Embodiment 1 in that a separation optical element is provided. In the following description, differences from Embodiment 1 are mainly described, and description of common points may be omitted or simplified.

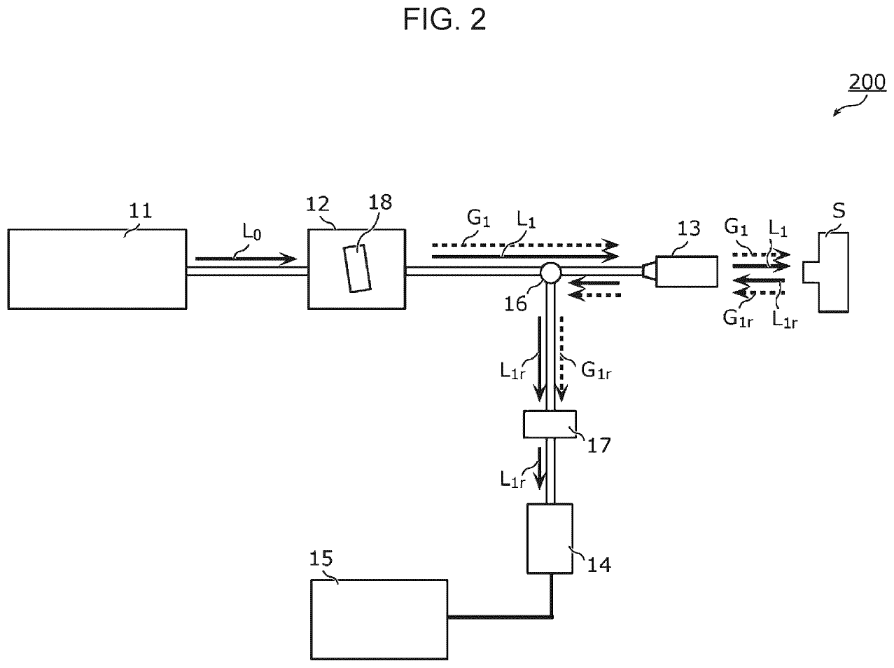

FIG. 2 is a schematic view schematically illustrating an example of a distance measurement system 200 according to the present embodiment. The distance measurement system 200 illustrated in FIG. 2 includes a separation optical element 17 in addition to the configuration of the distance measurement system 100 illustrated in FIG. 1.

The separation optical element 17 is disposed on a light incident side relative to a photodetector 14. Specifically, the separation optical element 17 is disposed between the photodetector 14 and an optical circulator 16.

The separation optical element 17 is an optical element whose passband includes a fundamental wave L₁ and whose cut-off band includes a harmonic G₁. A wavelength of reflected light L₁ᵣ of the fundamental wave L₁ is substantially identical to a wavelength of the fundamental wave L₁. A wavelength of reflected light G₁ᵣ of the harmonic G₁ is substantially identical to a wavelength of the harmonic G₁. Accordingly, the separation optical element 17 allows transmission of the reflected light L₁ᵣ generated by reflection on a surface of a target S and suppresses transmission of the reflected light G₁ᵣ of the harmonic G₁.

The separation optical element 17 can be, for example, selected from the group consisting of a long pass filter, and an isolator and an optical fiber that have wavelength selectivity. For example, the long pass filter allows transmission of light of a wavelength band longer than a predetermined wavelength and suppresses transmission of light of a wavelength band shorter than the predetermined wavelength. The predetermined wavelength is a value shorter than the wavelength of the fundamental wave L₁ and longer than the wavelength of the harmonic G₁. The isolator and the optical fiber that have wavelength selectivity selectively allow transmission of the fundamental wave L₁ and suppress transmission of the harmonic G₁.

According to the distance measurement system 200 according to the present embodiment, the separation optical element 17 can make it less likely that the reflected light G₁ᵣ generated by reflection on the surface of the target S is detected as noise or a signal unnecessary for distance measurement. This can make it less likely that signal processing is adversely influenced by the noise or the unnecessary signal, thereby improving accuracy of distance measurement.

### Embodiment 3

Next, Embodiment 3 is described.

A distance measurement system according to Embodiment 3 is different from the distance measurement system according to Embodiment 2 in that an adjustment mechanism that adjusts a posture or a temperature of an optical crystal 18 is provided. In the following description, differences from Embodiment 2 are mainly described, and description of common points may be omitted or simplified.

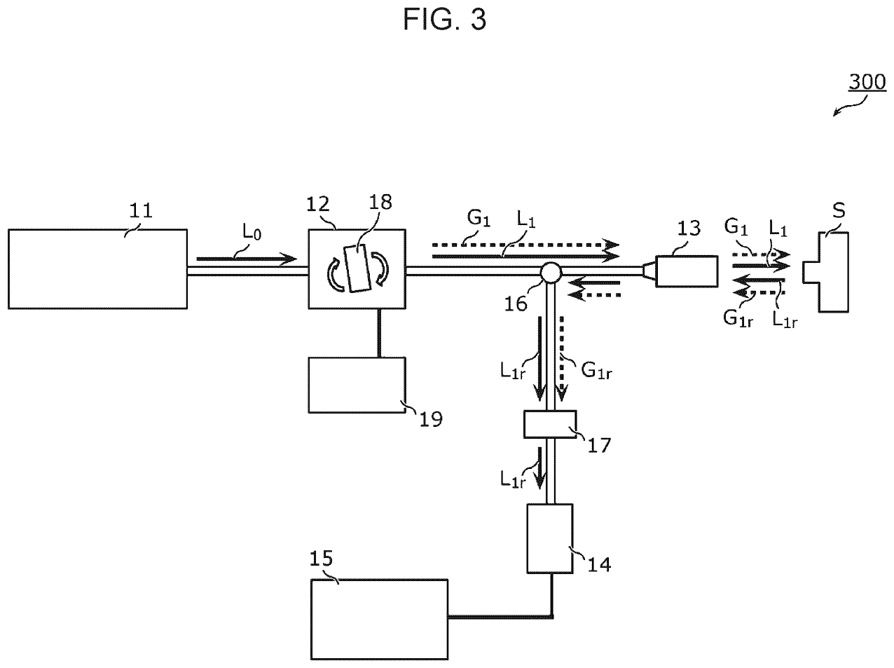

FIG. 3 is a schematic view schematically illustrating an example of a distance measurement system 300 according to the present embodiment. The distance measurement system 300 illustrated in FIG. 3 includes an adjustment mechanism 19 in addition to the configuration of the distance measurement system 200 illustrated in FIG. 2.

The adjustment mechanism 19 adjusts a temperature or a posture of the optical crystal 18. In the present embodiment, the optical crystal 18 is kept disposed on an optical axis of light L₀ emitted from a light source 11. The adjustment mechanism 19 includes, for example, a stepping motor, an actuator, or the like that rotates the optical crystal 18. When the optical crystal 18 rotates, the posture of the optical crystal 18 changes, and an angle between the incident light L₀ and an optical axis of the optical crystal 18 changes. This can change an intensity of a harmonic G₁ emitted from the optical crystal 18.

The adjustment mechanism 19 may include a temperature adjustment device that changes a temperature of the optical crystal 18. The temperature adjustment device is, for example, a Peltier device. When the temperature of the optical crystal 18 changes, a refractive index of the optical crystal 18 changes. This can change an intensity of the harmonic G₁ emitted from the optical crystal 18.

Note that the temperature of the optical crystal 18 tends to rise since the optical crystal 18 is irradiated with the light L₀. Therefore, the adjustment mechanism 19 may keep the temperature of the optical crystal 18 constant by cooling the optical crystal 18.

According to the distance measurement system 300 according to the present embodiment, the optical intensity of the harmonic G₁ can be adjusted. For example, in a case where guide light is not needed, the intensity of the harmonic G₁ is reduced, and an intensity of the fundamental wave L₁ for distance measurement is increased. This can improve S/N and realize high distance measurement accuracy in a short cumulative period.

Note that the temperature adjustment device is not limited to a Peltier device and may include, for example, a cooling sheet and an element that adjusts a position of the cooling sheet. The temperature adjustment device can lower the temperature of the optical crystal 18 by bringing the cooling sheet into contact with the optical crystal 18. Alternatively, the temperature adjustment device may be a heat generation element such as a heater.

### Embodiment 4

Next, Embodiment 4 is described.

A distance measurement system according to Embodiment 4 is different from the distance measurement system according to Embodiment 2 in that an adjustment mechanism that adjusts a position of an optical crystal 18 is provided. In the following description, differences from Embodiment 2 are mainly described, and description of common points may be omitted or simplified.

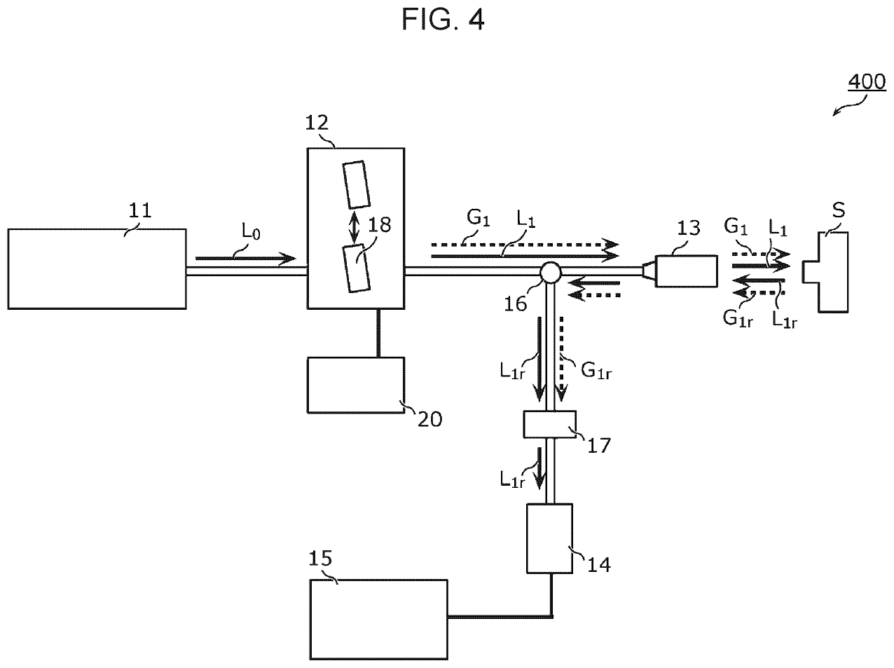

FIG. 4 is a schematic view schematically illustrating an example of a distance measurement system 400 according to the present embodiment. The distance measurement system 400 illustrated in FIG. 4 includes an adjustment mechanism 20 in addition to the configuration of the distance measurement system 200 illustrated in FIG. 2.

The adjustment mechanism 20 adjusts a position of the optical crystal 18. Specifically, the adjustment mechanism 20 adjusts the position of the optical crystal 18 so that the optical crystal 18 can be selectively located at a first position on a path of light L₀ emitted from a light source 11 and a second position deviated from the path of the light L₀. The adjustment mechanism 20 is an actuator, a stepping motor, or the like, and is not limited in particular.

In a case where the optical crystal 18 is located at the first position, a fundamental wave L₁ and a harmonic G₁ are emitted from the optical crystal 18. In a case where the optical crystal 18 is located at the second position, the light L₀ does not pass through the optical crystal 18, and therefore the light L₀, that is, the fundamental wave L₁ is emitted from an optical head 13, and the harmonic G₁ is not emitted. For example, to check a measurement position by using guide light, the adjustment mechanism 20 locates the optical crystal 18 at the first position on the path of the light L₀. In a case where there is no need to check the measurement position, the adjustment mechanism 20 locates the optical crystal 18 at the second position deviated from the path of the light L₀.

According to the distance measurement system 400 according to the present embodiment, in a case where guide light is not needed, the harmonic G₁ is not generated and thereby an optical intensity of the fundamental wave L₁ for distance measurement can be maximized. This can improve S/N and realize high distance measurement accuracy in a shorter cumulative period.

### OTHER EMBODIMENTS

Although the distance measurement systems according to one or more aspects have been described on the basis of the embodiments, the present disclosure is not limited to these embodiments. Various modifications of the present embodiment which a person skilled in the art can think of and combinations of constituent elements in different embodiments are also encompassed within the scope of the present disclosure without departing from the spirit of the present disclosure.

For example, displacement of the target S can be measured by a ToF method by using a pulse laser light source as the light source 11 in each of the above embodiments.

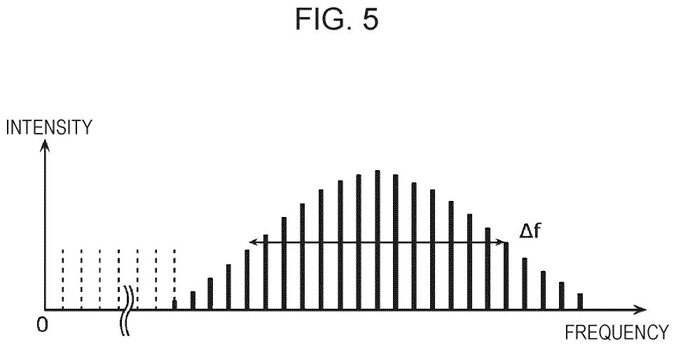

Furthermore, the displacement can be measured with higher accuracy by using an optical frequency comb light source as the light source 11 in each of the above embodiments. Laser light emitted from the optical frequency comb light source has a comb-shaped frequency spectrum formed by equally-spaced discrete lines, as illustrated in FIG. 5. Note that FIG. 5 schematically illustrates a frequency spectrum of light emitted from the optical frequency comb light source. In FIG. 5, the horizontal axis represents a frequency, and the vertical axis represents an intensity of light.

The laser light emitted from the optical frequency comb light source, that is, the light L₀ has a wide spectrum width. Specifically, the light L₀ has a wider spectrum width than a width of change of a phase-matched wavelength of the wavelength conversion module 12 caused by a change in temperature upon irradiation of light from the light source 11. The spectral width corresponds, for example, to a full width at half maximum Δf of an envelope of the comb-shaped frequency spectrum, as illustrated in FIG. 5.

The phase-matched wavelength of the wavelength conversion module 12 is a wavelength of incident light that satisfies a phase matching condition on which the optical crystal 18 generates a strong harmonic G₁ and is generally adjusted to match the wavelength of the fundamental wave L₁. As described above, the temperature of the optical crystal 18 of the wavelength conversion module 12 rises upon irradiation of the light L₀ from the light source 11. The optical crystal 18 expands due to the rise in temperature, and thereby the phase-matched wavelength changes. For example, even in a case where the phase-matched wavelength is adjusted to 1550 nm, the phase-matched wavelength changes due to the rise in temperature caused by irradiation of laser light.

The laser light emitted from the optical frequency comb light source has a wider spectrum width than a width of the change of the phase-matched wavelength caused by the rise in temperature. Therefore, even when the phase-matched wavelength changes from an original target value (e.g., 1550 nm), the laser light contains a wavelength component of a sufficient intensity that matches the phase-matched wavelength after the change. Therefore, the optical crystal 18 can generate a harmonic G₁ having sufficient intensity. In a case where LiNbO₃, which is a representative material, is used as the optical crystal 18, a width of change of the phase-matched wavelength caused by a change in temperature of 20° C.±10° C. assumed in an actual use environment is less than 2 nm. Therefore, by setting a spectrum width of the laser light emitted from the light source 11 to 2 nm or more, a decline in intensity of the harmonic G₁ caused by the change in temperature can be kept small. As described above, an optical frequency comb light source is suitable as a light source having such a spectrum width. In a case where a spectrum width of the optical frequency comb light source is wide, the spectrum width is outside a design wavelength range of an optical element such as a lens, and S/N of the distance measurement system decreases, and therefore the spectrum width is preferably 500 nm or less.

In each of the embodiments, in a case where an FMCW light source is used as the light source 11, a traveling speed can be measured concurrently with displacement of the target S. The FMCW light source emits temporally frequency-modulated laser light. The frequency modulation is, for example, linear modulation in which a rate of change is constant.

In this case, the distance measurement system divides the frequency-modulated laser light into two beams of light, that is, irradiation light with which the target S is to be irradiated and reference light. The distance and traveling speed of the target S can be calculated on the basis of a frequency difference between the irradiation light and the reference light, that is, a beat frequency.

For example, the photodetector 14 may be a detector that has sensitivity to the fundamental wave L₁ and does not have sensitivity to the harmonic G₁. This can lessen influence of the reflected light G₁ᵣ of the harmonic G₁ on signal processing and increase accuracy of distance measurement even in a case where the separation optical element 17 is not provided.

In each of the above embodiments, various changes, substitutions, additions, omissions, and the like can be made within the scope of the claims and a scope equivalent to the claims.

A distance measurement system according to the present disclosure can be used for distance measurement or displacement measurement. For example, the distance measurement system according to the present disclosure can be used for a displacement meter, a shape inspection device, and the like.

What is claimed is:

1. A distance measurement system comprising:
a light source;
a wavelength conversion module that generates a harmonic with which a target is to be irradiated as guide light by converting a wavelength of a part of a fundamental wave of light emitted from the light source;
a detector that detects reflected light generated by reflection, on the target, of the fundamental wave that has passed through the wavelength conversion module;
a processing circuit that calculates a distance to the target on a basis of a detection result of the detector; and
an optical element that is disposed on a light incident side relative to the detector and whose passband includes the fundamental wave and whose cut-off band includes the harmonic,
wherein the optical element is an isolator or an optical fiber having wavelength selectivity.

2. The distance measurement system according to claim 1, wherein
the wavelength conversion module includes an optical crystal that generates the harmonic by converting the wavelength of the part of the fundamental wave of the light emitted from the light source; and
the distance measurement system further comprises an adjustment mechanism that adjusts a temperature or a posture of the optical crystal.

3. The distance measurement system according to claim 1, wherein
the wavelength conversion module includes an optical crystal that generates the harmonic by converting the wavelength of the part of the fundamental wave of the light emitted from the light source; and
the distance measurement system further comprises an adjustment mechanism that adjusts a position of the optical crystal so that the optical crystal can be selectively located at a first position on a path of the light and a second position deviated from the path of the light.

4. The distance measurement system according to claim 1, wherein
an optical intensity of the harmonic is lower than an optical intensity of the fundamental wave that has passed through the wavelength conversion module.

5. The distance measurement system according to claim 1, wherein
the light source is a pulse laser light source.

6. The distance measurement system according to claim 1, wherein
the light source is an optical frequency comb light source.

7. The distance measurement system according to claim 6, wherein
the light has a spectrum width wider than a width of a change of a phase-matched wavelength of the wavelength conversion module caused by a change in temperature upon irradiation of the light from the light source.

8. The distance measurement system according to claim 7, wherein
the spectrum width of the light is greater than or equal to 2 nm and less than or equal to 500 nm.

9. The distance measurement system according to claim 1, wherein
the light source is a frequency modulated continuous wave light source.

10. A distance measurement system comprising:
a light source;
a wavelength conversion module that generates a harmonic with which a target is to be irradiated as guide light by converting a wavelength of a part of a fundamental wave of light emitted from the light source;
a detector that detects reflected light generated by reflection, on the target, of the fundamental wave that has passed through the wavelength conversion module; and
a processing circuit that calculates a distance to the target on a basis of a detection result of the detector;
wherein an optical intensity of the harmonic is lower than an optical intensity of the fundamental wave that has passed the wavelength conversion module.
